(19) United States
(12) Patent Application Publication
(10) Pub. No.: US 2008/0129508 A1
(43) Pub. Date: Jun. 5, 2008

(54) METHOD AND SYSTEM FOR PAIRING READING MATERIAL AND AUDIO-VISUAL EQUIPMENT USING RFID TAGS

(76) Inventors: Gregory Jensen Boss, American Fork, UT (US); Andrew R. Jones, Round Rock, TX (US); Kevin C. McConnell, Austin, TX (US); Ori Pomerantz, Austin, TX (US)

Correspondence Address: IBM CORP (YA);C/O YEE & ASSOCIATES PC, P.O. BOX 802333, DALLAS, TX, 75380, US

(21) Appl. No.: 11/565,686

(22) Filed: Dec. 1, 2006

(51) Int. Cl. G08B 13/14

(52) U.S. Cl. 340/572.4; 340/686.6

(57) ABSTRACT

A method, system, apparatus, or computer program product is presented for using a book in conjunction with an electronic device. A radio-frequency identification (RFID) reader within the electronic device is operated to read an RFID tag identifier from an RFID tag in the book. The RFID tag identifier is employed by the electronic device to search memory in the electronic device in order to find audio data, visual data, or audio-visual data that is associated with the book. The audio data, visual data, or audio-visual data is retrieved from non-volatile memory in the electronic device. The audio data, visual data, or audio-visual data is then presented by the electronic device to a user of the electronic device.

### BACKGROUND OF THE INVENTION

1. Field of the Invention

The present invention relates to an improved data processing system and, in particular, to a method and apparatus for electronic educational toys.

2. Description of Related Art

As electronic devices have become more ubiquitous and less expensive to manufacture, electronic toys have become more common. Since educational toys are a significant portion of the market for toys, electronic educational toys have also become common. For example, there are many electronic toys that assist children in learning to read, spell, identify animals and objects, and many other things.

Many electronic educational toys can be described as electronically-enhanced books, which often use printed matter in combination with an electronic device.

Although different toys combine the use of printed matter with an electronic device in different ways, the reading material is usually accompanied by a software module that is to be used by the electronic device concurrently with the reading material. For example, a toy may comprise: an electronic device that provides audio and interactive capabilities; a book that contains visual elements; and a cartridge to be inserted into the electronic device such that the cartridge contains the software for the audio and interactive functionality that is appropriate for the associated book. The book and the cartridge are usually bundled and sold together. However, given the tendencies of children, the book and the software cartridge are physically separate items that tend to be damaged or lost.

Therefore, it would be advantageous to improve an electronic device or toy that is to be used with a book or other printed publication along with accompanying software having voice, audio, interactive, or visual functionality such that the electronic device and printed publication are easier to maintain.

### SUMMARY OF THE INVENTION

A method, system, apparatus, or computer program product is presented for using a book in conjunction with an electronic device. A radio-frequency identification (RFID) reader within the electronic device is operated to read an RFID tag identifier from an RFID tag in the book. The RFID tag identifier is employed by the electronic device to search memory in the electronic device in order to find audio data, visual data, or audio-visual data that is associated with the book. The audio data, visual data, or audio-visual data is retrieved from non-volatile memory in the electronic device. The audio data, visual data, or audio-visual data is then presented by the electronic device to a user of the electronic device.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2A depicts an electronic device that contains an RFID tag reader;

FIG. 2B depicts a book with an RFID tag that is used in conjunction with an electronic device that has an RFID tag reader;

FIG. 3 depicts a block diagram that shows some of the subsystems within an electronic device having an RFID tag reader and an RFID-associative memory; and

FIG. 4 depicts a flowchart that shows a process for using an electronic device with an RFID tag reader along with a book that contains an embedded RFID tag.

### DETAILED DESCRIPTION OF THE INVENTION

In general, the devices that may comprise or relate to the present invention include a wide variety of data processing technology. Therefore, as background, a typical organization of hardware and software components within a data processing system is described prior to describing the present invention in more detail.

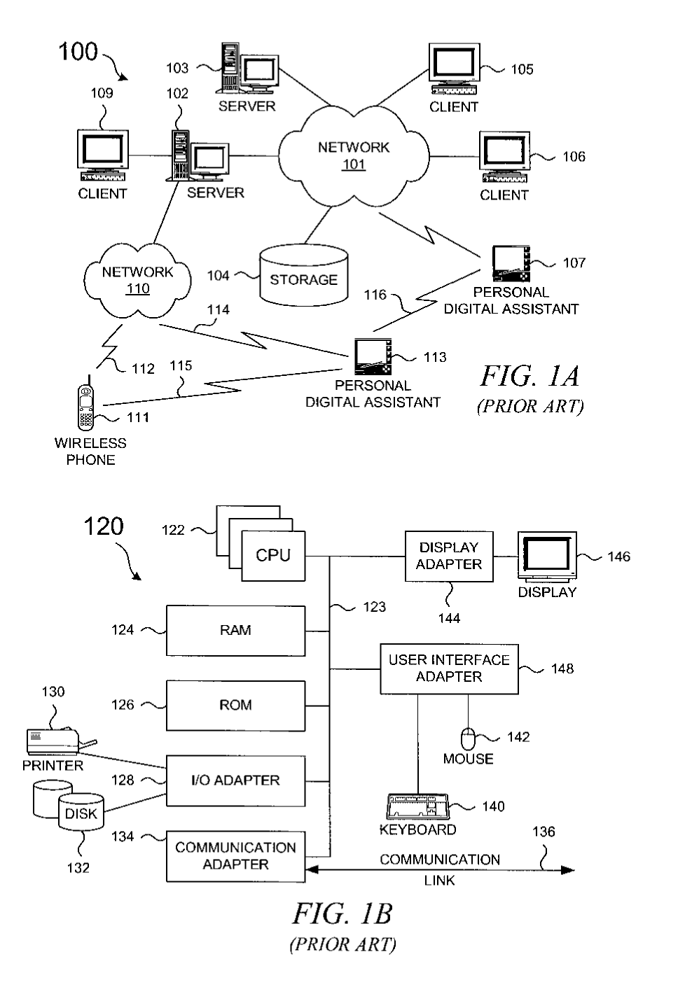

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to an improved electronic device that is employed along with a book comprising printed matter and a radio frequency identification (RFID) tag, as described in more detail below with respect to the remaining figures.

In a typical RFID system, individual objects that are to be identified are equipped with a small, inexpensive RFID tag. The RFID tag contains a transponder, sometimes along with a digital memory chip that has very little storage capacity or functionality. The RFID tag is given a unique electronic code, called the RFID tag identifier. The RFID tag has an integrated circuit/antenna that encodes the RFID tag identifier, possibly along with other data, within its response signal. Some types of RFID tags are based on technologies in which a passive RFID tag does not require a power source. For example, a particular passive RFID tag is uniquely identified by reflecting a unique response signal when bombarded with a special interrogation signal; the incoming signal provides the power to generate the response signal.

In a typical RFID system, an interrogator unit in an RFID tag reader comprises an antenna packaged with a transceiver and decoder that emits a signal that activates the RFID tag so the RFID tag reader can read data from the RFID tag. When an RFID tag is in close proximity to the RFID tag reader, the RFID tag responds to the RFID tag reader's activation signal. The RFID tag reader receives the response signal from the RFID tag, and the RFID tag reader decodes the data that is received in the RFID tag's response signal; the received data includes the RFID tag identifier for the RFID tag. The received data is then passed from the RFID tag reader to its host data processing system for processing.

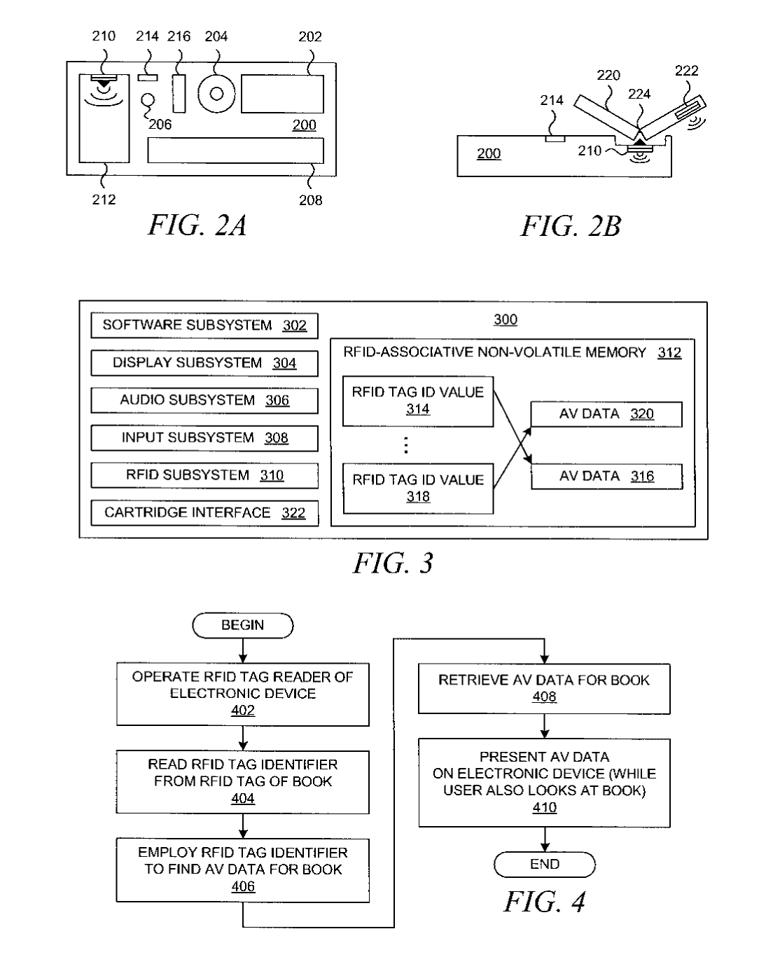

With reference now to FIG. 2A, an electronic device having an RFID tag reader is shown in accordance with an embodiment of the present invention. Electronic device 200 may be a general purpose computer, as shown in FIG. 1B, or electronic device 200 could represent data processing systems with other form factors, such as those that are shown in FIG. 1A. Electronic device 200 may include display 202, speaker 204, microphone 206, and keyboard 208 or other input device. However, a typical embodiment of the present invention would characterize electronic device 200 as a special-purpose data processing system; although the computational devices that are shown in FIG. 1A may be similar to electronic device 200 and have similar features and computational abilities, electronic device 200 may be specifically manufactured to operate with specific modalities. In any case, electronic device 200 is a type of data processing system.

However, in any embodiment of the present invention, electronic device 200 includes radio frequency identification (RFID) tag reader 210, which is used to obtain an RFID tag identifier from an RFID tag in specially manufactured books, as explained in more detail with respect to FIG. 2B.

Electronic device 200 may also include book slot 212 and user-activation mechanism 214, as explained in more detail with respect to FIG. 2B. Electronic device 200 may also include cartridge receptacle 216, as explained in more detail with respect to FIG. 3.

With reference now to FIG. 2B, a book and an electronic device are shown, wherein the book has an RFID tag that is used in conjunction with the electronic device that has an RFID tag reader in accordance with an embodiment of the present invention. Electronic device 200 has RFID tag reader 210 in a manner similar to that shown in FIG. 2A.

Book 220 comprises reading material or printed matter over a plurality of pages. Book 220 may comprise one or more other manufactured articles such that book 220 does not comprise solely printed pages. For example, book 220 may comprise a hard cover, a soft cover, and binding materials, such as glue, metal staples, a rigid plastic spine, etc.; hence, book 220 may be regarded as a printed publication except that, in any embodiment of the present invention, book 220 comprises an RFID tag 222. RFID tag 222 may be affixed to the exterior of book 220, or RFID tag 222 may be embedded within book 220, e.g., on an interior page, within the cover, or within the spine of book 220.

In a manner that is typical of RFID tags as described above, RFID tag 222 is read by RFID tag reader 210; in so doing, RFID tag reader 210 receives an RFID tag identifier from RFID tag 222 in its response signal. The received RFID tag identifier not only indicates some type of identification information about RFID tag 222 but also indicates some type of identification information about book 220. In one embodiment, all books with a given title, i.e. all books having the same content, have identical RFID tags; when RFID tag 222 is read to received its RFID tag identifier, there is a direct correspondence between the RFID tag identifier value and the book title/content. In an alternative embodiment, the received RFID tag identifier may be a unique ID value that uniquely identifies RFID tag 222 amongst all other RFID tags that are also embedded within compatible books; in this case, a portion of the RFID tag identifier may indicate the book title/content. For example, an RFID tag identifier for RFID tag 222 may be equal to 0x'10F13A75682BCD′, wherein the prefix 0x′10F13A75′ indicates the book title/content and the suffix 0x′682BCD′ indicates a serial number for RFID tag 222. In this manner, the RFID tag identifier may be encoded to include many informational data items, but the RFID tag identifier is associated with a particular book title. Since the RFID tag identifier can be associated with a particular book title, the RFID tag identifier can be associated with any audio data, visual data, or audio-visual data that is also associated with a book title, as described in more detail with respect to FIG. 3.

Electronic device 200 sends an interrogation or activation signal for any book, including book 220, when necessary or when initiated to do so. An RFID tag reading procedure may be initiated or performed in a variety of manners, some of which are discussed below. For example, when a user of electronic device 200 moves book 220 into close proximity with electronic device 200 or RFID tag reader 210, RFID tag reader 210 may detect the close proximity of RFID tag 222.

Alternatively, the user may touch book 220 to RFID tag reader 210. In one embodiment, electronic device 200 is manufactured to have a special shape or slot, such as book slot 212 that is shown in FIG. 2A, that accepts a special shape of spine 224 of book 220. Placement of book 220 into slot 212 causes spine 224 to contact RFID tag reader 210, which may then initiate a sequence of reading steps to obtain an RFID tag identifier from RFID tag 222; the contact between RFID tag reader 210 and book 220 may be electromechanical, or it may be electrical with a detectable metal contact on spine 224.

In another alternative embodiment, the user may select user-activation mechanism 214, which may be a simple electrical button or an electromechanical mechanism like a push button. Input mechanism 214 generates a signal to electronic device 200 that indicates that the user is ready to begin using book 220, e.g., as compared to another book that the user may have been using previously. In response to the user-selection of input mechanism 214, RFID tag reader 210 reads the RFID tag identifier from RFID tag 222.

With reference now to FIG. 3, a block diagram shows some of the subsystems within an electronic device having an RFID tag reader and an RFID-associative memory in accordance with an embodiment of the present invention. Electronic device 300 that is shown in FIG. 3 is identical or similar to electronic device 200 that is shown in FIG. 2A. Software subsystem 302 contains software for operating electronic device 300, including an operating system and application programs for user enjoyment of electronic device 300. Display subsystem 304 contains an interface for presenting visual data on display 202. Audio subsystem 306 contains an interface for presenting audio data on speaker 204 or for receiving voice input from microphone 206. Input subsystem 308 contains an interface for controlling any user input devices, including user-selection mechanism 214 and keyboard 208. RFID subsystem 310 contains an interface for controlling RFID tag reader 210.

RFID-associative non-volatile memory 312 contains non-volatile memory for storing RFID tag identifiers (or portions of RFID tag identifiers) along with audio data, visual data, or audio-visual data that is associated with RFID tag identifiers. As explained above, the association between an RFID tag identifier and a book title/content also provides an association between an RFID tag identifier and audio data, visual data, or audio-visual data that is also associated with a book title/content. In the example that is shown in FIG. 3, RFID tag identifier value 314 is associated with audio-visual (AV) data 316, and RFID tag identifier value 318 is associated with audio-visual (AV) data 320. The RFID tag identifier values may be stored within a lookup table, a translation-lookaside buffer, or some other well-known searchable data structure, whereby the RFID tag identifier value may be used to obtain a memory location reference at which the associated AV data is stored.

Cartridge subsystem 310 contains an interface for controlling cartridge slot 216. RFID-associative non-volatile memory 312 may be renewed or updated by insertion of a non-volatile memory cartridge, e.g., a flash memory cartridge, into cartridge slot 216. A cartridge would contain one or more RFID tag identifier values that are stored in an associative manner with one or more sets of audio data, visual data, or audio-visual data that correspond to one or more book titles. In this manner, electronic device 300 can be updated to include software for use with books that are published after electronic device 300 is manufactured. In a similar manner, electronic device 300 may be connected to a network through a wired or wireless connection mechanism (not shown in the figures) for downloading one or more sets of audio data, visual data, or audio-visual data that correspond to one or more book titles.

With reference now to FIG. 4, a flowchart shows a process for using an electronic device with an RFID tag reader along with a book that contains an embedded RFID tag in accordance with an embodiment of the present invention. The process that is shown in FIG. 4 commences when an RFID tag reader in an electronic device is operated (step 402). The operation of the RFID tag reader can be initiated in a variety of ways, as discussed above with respect to FIG. 2B, e.g., by placing a book on the electronic device.

The RFID tag reader then reads an RFID tag identifier from an RFID tag that is embedded within the book of interest (step 404), i.e. the book that was placed on the electronic device. As discussed above, the RFID tag reader may perform a series of steps in order to obtain the RFID tag identifier. The electronic device may also process or decode the RFID tag identifier, if necessary, to obtain a value that can be used further.

The RFID tag identifier is then employed to find audio data, visual data, or audio-visual data that has previously been stored within non-volatile memory within the electronic device (step 406). The manner in which one or more data structures are configured to associate RFID tag identifier values with AV data may vary, as described above with respect to FIG. 3; hence, a variety of steps may be performed in order to accomplish a lookup function.

After the AV data is located, the AV data is retrieved from the non-volatile memory (step 408). It should be noted that the AV data may be obtained through multiple lookup and/or retrieval operations.

The AV data is then processed as necessary in order to present the data to the user through the appropriate output mechanisms (step 410), thereby giving an audio, visual, or audio-visual presentation to the user of the electronic device, presumably while the user is also viewing the book that contains the embedded RFID tag, thereby giving the user an electronically enhanced experience while looking at the book. Additional functions may also be performed while the AV presentation is performed, e.g., by prompting the user to perform enjoyable interactive steps. The process that is shown in FIG. 4 is then concluded.

At some later point in time, the user may then repeat the process by using a different book with the electronic device. Otherwise, at some point in time, the user may update the electronic device to obtain other AV data, as described with respect to FIG. 3.

The advantages of the present invention should be apparent in view of the detailed description that is provided above. After the audio data, visual data, or audio-visual data that is associated with a book is stored within non-volatile memory in the electronic device, the user is not burdened with the responsibility of caring for another object in addition to the electronic device and the book. The audio data, visual data, or audio-visual data can be presented by the electronic device whenever the user has an RFID-tagged book that can be used in conjunction with the electronic device. In one embodiment, the non-volatile memory in the electronic device contains enough storage space to hold any of the audio data, visual data, or audio-visual data that is associated with any compatible book. In other embodiments, the non-volatile memory can be updated or restored with audio data, visual data, or audio-visual data for compatible books through a variety of procedures.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

Certain computational tasks may be described as being performed by functional units. A functional unit may be represented by a routine, a subroutine, a process, a subprocess, a procedure, a function, a method, an object-oriented object, a software module, an applet, a plug-in, an ActiveX™ control, a script, or some other component of firmware or software for performing a computational task.

The descriptions of elements within the figures may involve certain actions by either a client device or a user of the client device. One of ordinary skill in the art would understand that requests and/or responses to/from a client device are sometimes initiated by a user and at other times are initiated automatically by a client, often on behalf of a user of the client. Hence, when a client or a user of a client is mentioned in the description of the figures, it should be understood that the terms “client” and “user” can often be used interchangeably without significantly affecting the meaning of the described processes.

The descriptions of the figures herein may involve an exchange of information between various components, and the exchange of information may be described as being implemented via an exchange of messages, e.g., a request message followed by a response message. It should be noted that, when appropriate, an exchange of information between computational components, which may include a synchronous or asynchronous request/response exchange, may be implemented equivalently via a variety of data exchange mechanisms, such as messages, method calls, remote procedure calls, event signaling, or other mechanism.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for using a book in conjunction with an electronic device, the method comprising:
operating a radio-frequency identification (RFID) reader within the electronic device to read an RFID tag identifier from an RFID tag in the book;
employing the RFID tag identifier by the electronic device to search memory in the electronic device in order to find audio data, visual data, or audio-visual data that is associated with the book;
retrieving the audio data, visual data, or audio-visual data from non-volatile memory in the electronic device; and
presenting the audio data, visual data, or audio-visual data by the electronic device to a user of the electronic device.

2. The method of claim 1 further comprising:
activating the RFID reader by detecting close proximity of the RFID tag in the book with the RFID reader.

3. The method of claim 1 further comprising:
activating the RFID reader by contact of the book with the electronic device.

4. The method of claim 1 further comprising:
activating the RFID reader by user-selection of an input mechanism on the electronic device.

5. The method of claim 1 further comprising:
updating the audio data, visual data, or audio-visual data in non-volatile memory in the electronic device through a network connection for the electronic device.

6. The method of claim 1 further comprising:
updating the audio data, visual data, or audio-visual data in non-volatile memory in the electronic device through a cartridge that is connected to the electronic device.

7. A computer program product on a computer-readable medium for use in an electronic device for using a book in conjunction with the electronic device, the computer program product comprising:
means for operating a radio-frequency identification (RFID) reader within the electronic device to read an RFID tag identifier from an RFID tag in the book;
means for employing the RFID tag identifier by the electronic device to search memory in the electronic device in order to find audio data, visual data, or audio-visual data that is associated with the book;
means for retrieving the audio data, visual data, or audio-visual data from non-volatile memory in the electronic device; and
means for presenting the audio data, visual data, or audio-visual data by the electronic device to a user of the electronic device.

8. The computer program product of claim 7 further comprising:
means for activating the RFID reader by detecting close proximity of the RFID tag in the book with the RFID reader.

9. The computer program product of claim 7 further comprising:
means for activating the RFID reader by contact of the book with the electronic device.

10. The computer program product of claim 7 further comprising:
means for activating the RFID reader by user-selection of an input mechanism on the electronic device.

11. The computer program product of claim 7 further comprising:
means for updating the audio data, visual data, or audio-visual data in non-volatile memory in the electronic device through a network connection for the electronic device.

12. The computer program product of claim 7 further comprising:
means for updating the audio data, visual data, or audio-visual data in non-volatile memory in the electronic device through a cartridge that is connected to the electronic device.

13. An apparatus for using a book in conjunction with an electronic device, the apparatus comprising:
means for operating a radio-frequency identification (RFID) reader within the electronic device to read an RFID tag identifier from an RFID tag in the book;
means for employing the RFID tag identifier by the electronic device to search memory in the electronic device in order to find audio data, visual data, or audio-visual data that is associated with the book;
means for retrieving the audio data, visual data, or audio-visual data from non-volatile memory in the electronic device; and
means for presenting the audio data, visual data, or audio-visual data by the electronic device to a user of the electronic device.

14. The apparatus of claim 13 further comprising:
means for activating the RFID reader by detecting close proximity of the RFID tag in the book with the RFID reader.

15. The apparatus of claim 13 further comprising:
means for activating the RFID reader by contact of the book with the electronic device.

16. The apparatus of claim 13 further comprising:
means for activating the RFID reader by user-selection of an input mechanism on the electronic device.

17. The apparatus of claim 13 further comprising:
means for updating the audio data, visual data, or audio-visual data in non-volatile memory in the electronic device through a network connection for the electronic device.

18. The apparatus of claim 13 further comprising:
means for updating the audio data, visual data, or audio-visual data in non-volatile memory in the electronic device through a cartridge that is connected to the electronic device.
